(19) United States
(12) Patent Application Publication
(10) Pub. No.: US 2006/0043817 A1
(43) Pub. Date: Mar. 2, 2006

(54) DC brush motor

(75) Inventors: Shigekazu Nagai, Adachi-ku (JP); Takeshi Hirose, Moriya-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 11/207,810

(22) Filed: Aug. 22, 2005

(30) Foreign Application Priority Data
Aug. 24, 2004 (JP) 2004-243235

(51) Int. Cl. H02K 13/00

(52) U.S. Cl. 310/219

(57) ABSTRACT

A DC brush motor comprises an inner rotor which includes a shaft and two permanent magnets provided on a surface of the shaft, a substantially cylindrical outer stator which is arranged opposingly to the permanent magnets outside the inner rotor via an air gap, and coils, i.e., first and second coils, which are arranged in a plurality of slots formed on an inner surface of the outer stator respectively and which have surfaces molded with resin.

### BACKGROUND OF THE INVENTION

1. Field of the Invention

The present invention relates to a DC brush motor which includes a brush and a coil.

2. Description of the Related Art

In a DC (direct current) brush motor concerning the conventional technique, a coil is arranged in a slot of an inner rotor, and an outer stator, which has permanent magnets, is arranged outside the inner rotor while being separated by a predetermined distance from the inner rotor (see Japanese Laid-Open Patent Publication Nos. 2003-169437 and 2003-230234). A commutator is provided on the surface of a shaft which serves as the central shaft of the inner rotor. The coil is electrically connected to the commutator. Brushes make contact with the surface of the commutator in order to supply the DC current to the coil from the outside.

In this case, when the DC current is allowed to flow to the commutator from the outside via the brushes, the DC current flows through the coil via the commutator. Torque is generated on the inner rotor in accordance with the action of the magnetic flux which is generated from the coil by the DC current and the magnetic flux which intersects the inner rotor from the permanent magnets. The inner rotor is rotated about the central axis of the shaft.

In the DC brush motor concerning the conventional technique, for example, when the DC brush motor is used in an environment of high temperature and high humidity, or the thrust force is to be obtained in a state in which the rotation of the shaft is stopped when the rotary driving force is transmitted to another apparatus via the shaft, then a large amount of heat is generated from the coil to heat the inner rotor as compared with an ordinary state of use. In such a situation, in the DC brush motor as described above, the heat, which is generated by the inner rotor, cannot be released outside efficiently due to the air gap existing between the inner rotor and the outer stator and the permanent magnets for the outer stator.

### SUMMARY OF THE INVENTION

An object of the present invention is to provide a DC brush motor which makes it possible to efficiently release heat generated from a coil.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a sectional view illustrating a DC brush motor according to an embodiment of the present invention;

FIG. 2 is a sectional view taken along a line II-II shown in FIG. 1;

FIG. 3 is a circuit diagram including a commutating section shown in FIG. 1;

FIG. 4 is a sectional view illustrating major parts of the commutating section taken along a line IV-IV shown in FIG. 1;

FIG. 5 is a side view illustrating a modified embodiment of the commutating section shown in FIG. 3;

FIG. 6 is a sectional view illustrating major parts of the commutating section taken along a line VI-VI shown in FIG. 1;

FIG. 7 is a sectional view illustrating major parts of the commutating section taken along a line VII-VII shown in FIG. 1;

FIG. 8 is a perspective view illustrating the provision of the DC brush motor shown in FIG. 1 in an electric clamp;

FIG. 9 is a perspective view illustrating the provision of the DC brush motor shown in FIG. 1 in an electric actuator; and

FIG. 10 is a perspective view illustrating the provision of the DC brush motor shown in FIG. 1 in an electric actuator.

### DESCRIPTION OF THE PREFERRED EMBODIMENTS

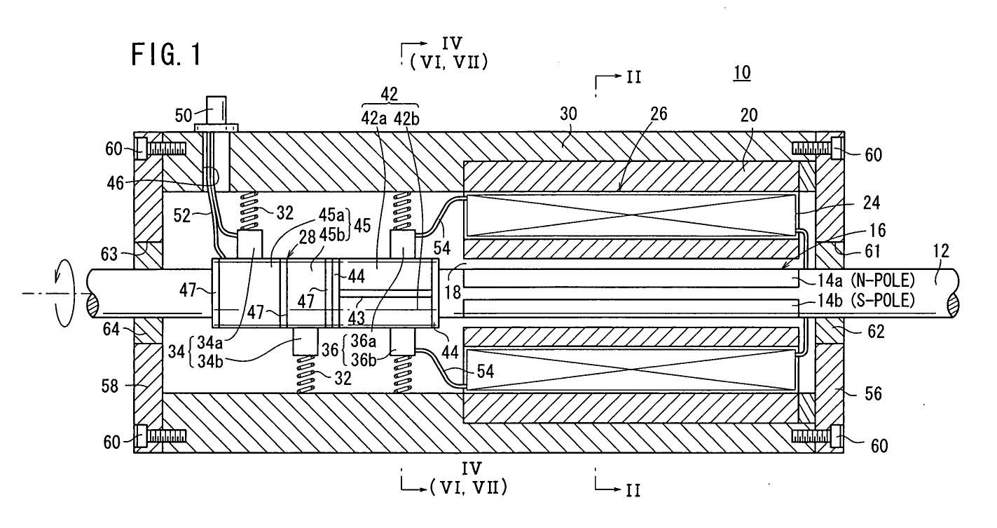

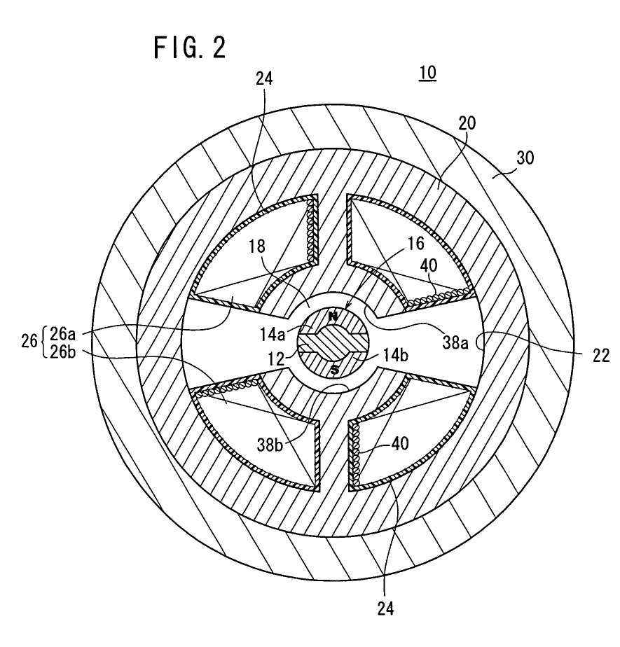

A DC brush motor 10 shown in FIGS. 1 and 2 comprises an inner rotor 16 which is provided with a shaft 12 and two permanent magnets 14a, 14b (N-pole and S-pole) arranged on the surface of the shaft 12, a substantially cylindrical outer stator 20 which is arranged opposingly to the permanent magnets 14a, 14b outside the inner rotor 16 with an air gap 18 interposing therebetween, stator coils 26 (hereinafter referred to as “first and second coils 26a, 26b” as well) which are arranged respectively in two slots 22 formed on the inner surface of the outer stator 20 and each of which has its surface molded with a resin 24, a substantially cylindrical commutating section 28 which is arranged on the surface of the shaft 12 while being separated from the permanent magnets 14a, 14b, a substantially cylindrical motor housing 30 which accommodates the outer stator 20, current-supplying brushes 34 (hereinafter referred to as “first and second current-supplying brushes 34a, 34b” as well) each of which has one end connected to the inner surface of the motor housing 30 via a spring 32 and the other end allowed to make contact with the surface of the commutating section 28, and coil-connecting brushes 36 (hereinafter referred to as “first and second coil-connecting brushes 36a, 36b” as well).

The shaft 12 is composed of a conductive material. However, the shaft 12 may be composed of an unillustrated insulating material. Alternatively, the shaft 12 may be composed of an unillustrated conductive material coated with an insulating material.

As for the permanent magnets 14a, 14b, substantially circular arc-shaped magnetic members are magnetized into the N-pole and the S-pole respectively to form the permanent magnets, and they are arranged in cutout portions of the shaft 12. In this arrangement, parts of the shaft 12 may be magnetized into the N-pole and the S-pole in the radial direction respectively to form the permanent magnets 14a, 14b. Alternatively, a plurality of magnetic members, which correspond to the number of poles of the DC brush motor 10, may be magnetized into the N-pole or the S-pole respectively to construct the permanent magnets.

The outer stator 20 is constructed such that a plurality of carbon steel plates containing silicon (silicon steel plates having the shape as shown in FIG. 2) are stacked in the longitudinal direction of the shaft 12. First and second teeth sections 38a, 38b, which are substantially Y-shaped in the direction toward the inner rotor 16, are formed on the inner surface of the outer stator 20. In this arrangement, the first and second teeth sections 38a, 38b are arranged at an interval of 180° with respect to the central axis of the shaft 12. The plurality of slots 22 are formed by the gaps between the first teeth section 38a and the second teeth section 38b. The first and second coils 26a, 26b are arranged in the slots 22.

The first and second coils 26a, 26b are formed such that copper wires 40, each of which is coated with an insulating material and each of which has a round cross-sectional shape or a rectangular cross-sectional shape, are wound around the first and second teeth sections 38a, 38b respectively, and the entire wound copper wires 40 are molded with the resin 24 (see FIG. 1).

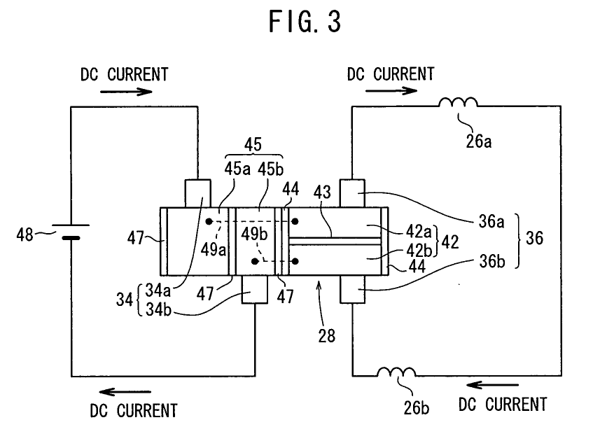

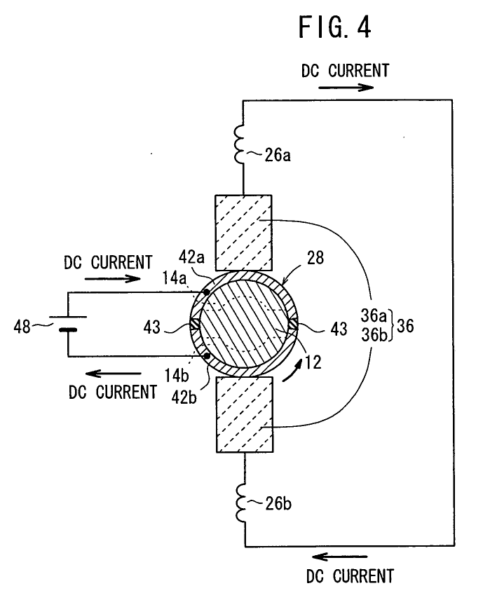

As shown in FIGS. 3 and 4, the first coil 26a is electrically connected to the first coil-connecting brush 36a, and the second coil 26b is electrically connected to the second coil-connecting brush 36b.

As shown in FIGS. 1 to 4, the commutating section 28 includes commutator pieces 42 (first and second commutator pieces 42a, 42b) each of which is composed of a substantially circular arc-shaped conductive material, and slip rings 45 (first and second current-supplying rings 45a, 45b) each of which is composed of a substantially annular conductive material and which are fitted to the outer circumferential surface of the shaft 12.

In this arrangement, the first commutator piece 42a is electrically insulated from the second commutator piece 42b by two insulating sections 43. Both ends of the first and second commutator pieces 42a, 42b and the respective insulating sections 43 are arranged and fixed onto the surface of the shaft 12 by tightening rings 44, thereby constructing the commutator. The tightening rings 44, the first current-supplying ring 45a, and the second current-supplying ring 45b are electrically insulated from each other respectively by a plurality of annular insulating sections 47. Further, unillustrated two cutouts, which are separated from each other and which extend in the axial direction of the shaft 12, are formed on the inner circumferential surface of each of the rings 45a, 45b and on the inner circumferential surface of each of the insulating sections 47. Copper wires 49a, 49b (see FIG. 3), each of which has the surface coated with an insulating member, are arranged in the cutouts. The copper wire 49a electrically connects the first current-supplying ring 45a and the first commutator piece 42a, and the copper wire 49b electrically connects the second current-supplying ring 45b and the second commutator piece 42b.

Accordingly, the substantially cylindrical commutating section 28 is constructed on the surface of the shaft 12.

The number of the first and second commutator pieces 42a, 42b is the same as the number of the first and second coils 26a, 26b. The first and second commutator pieces 42a, 42b are arranged at an interval of 180° with respect to the central axis of the shaft 12.

The motor housing 30 shown in FIGS. 1 and 2 is composed of the conductive material with the coated surface. However, the motor housing 30 may be composed of an unillustrated insulating material. The interior of the motor housing 30 includes a portion in which the outer stator 20 and the stator coils 26 are accommodated, and a portion in which the commutating section 28 is accommodated. A hole 46, which penetrates from the inner circumferential surface to the outer circumferential surface of the motor housing 30, is provided through the side surface of the motor housing 30. A connector 50, which is connected to a DC power source 48 as shown in FIGS. 3 and 4, is provided on the outer circumferential surface of the motor housing 30 so that the hole 46 is covered therewith from the outside.

The first and second current-supplying brushes 34a, 34b and the first and second coil-connecting brushes 36a, 36b (see FIGS. 1, 3, and 4) are composed of conductive materials including, for example, carbonaceous materials, graphite materials, electrographite materials, and metal graphite materials. The first and second current-supplying brushes 34a, 34b are connected to the connector 50 respectively via pigtails 52. In this arrangement, the first and second current-supplying brushes 34a, 34b are arranged at an interval of 180° with respect to the central axis of the shaft 12. The first current-supplying brush 34a makes contact with the surface of the first current-supplying ring 45a, and the second commutator piece 42b makes contact with the surface of the second current-supplying ring 45b.

The first and second coil-connecting brushes 36a, 36b are also connected to the first and second coils 26a, 26b respectively via pigtails 54. In this arrangement, the first and second coil-connecting brushes 36a, 36b are arranged at an interval of 180° with respect to the central axis of the shaft 12. The first and second coil-connecting brushes 36a, 36b make contact with the first and second commutator pieces 42a, 42b or the surface of the insulating section 43. Further, the spring 32 is a spring composed of an insulating material, or a spring coated with an insulating material.

In the DC brush motor 10, the openings at the both ends of the motor housing 30 are covered with lid members 56, 58 (see FIG. 1) each of which is composed of an insulating material or a conductive material having a surface coated with an insulating material. Further, the lid members 56, 58 are fixed to the both ends of the motor housing 30 respectively by a plurality of bolts 60. Holes 61, 63, which are coaxial with the shaft 12, are provided at central portions of the lid members 56, 58. Bearings 62, 64, which have holes having approximately the same inner diameter as the diameter of the shaft 12, are arranged coaxially with the shaft 12 in the holes 61, 63, respectively. Accordingly, the shaft 12 is capable of penetrating through the respective holes to protrude to the outside.

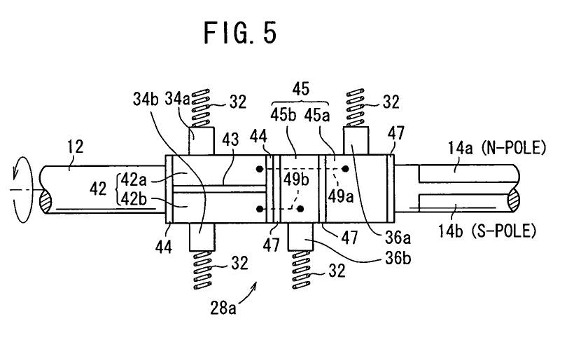

The DC brush motor 10 according to the embodiment of the present invention may be constructed as shown in FIG. 5 in relation to a commutating section 28a concerning a modified embodiment. The commutator pieces 42a, 42b may be arranged so as to make contact with the first and second current-supplying brushes 34a, 34b. Further, the first current-supplying ring 45a may be arranged so as to make contact with the first coil-connecting brush 36a, and the second current-supplying ring 45b may be arranged so as to make contact with the second coil-connecting brush 36b.

The DC brush motor 10 according to the embodiment of the present invention is constructed as described above. Next, its operation, function, and effect will be explained.

An explanation will now be made about a situation as shown in FIGS. 1 to 4 in which the DC current is allowed to flow through the first and second coils 26a, 26b in a state in which the permanent magnet 14a is magnetized into the N-pole, and the permanent magnet 14b is magnetized into the S-pole. For the purpose of convenience, the following explanation will be made in which the permanent magnet 14a is referred to as the “N-pole magnet 14a”, and the permanent magnet 14b is referred to as the “S-pole magnet 14b”.

With reference to FIGS. 1 and 2, the N-pole magnet 14a is arranged on the upper side of the shaft 12, and the S-pole magnet 14b is arranged on the lower side of the shaft 12. In this case, when the DC current is allowed to flow to the first current-supplying brush 34a from the positive electrode of the DC power source 48 (see FIG. 3) via the connector 50 and the pigtail 52, as shown in FIG. 4, the DC current flows through the first commutator piece 42a via the first current-supplying ring 45a and the copper wire 49a (see FIG. 3). Further, the DC current flows via the first commutator piece 42a from the first coil-connecting brush 36a to the first coil 26a.

The DC current, which flows to the first coil 26a, flows from the first coil 26a to the second coil 26b. The DC current flows via the second coil-connecting brush 36b to the second commutator piece 42b. Further, the DC current, which flows through the second commutator piece 42b, flows to the second current-supplying brush 34b via the copper wire 49b and the second current-supplying ring 45b. The DC current flows to the negative electrode of the DC power source 48 via the pigtail 52 and the connector 50.

The magnetic fluxes are generated from the first and second coils 26a, 26b by the DC current. The respective magnetic fluxes extend from the first and second teeth sections 38a, 38b (see FIG. 2) of the outer stator 20 via the air gap 18 to intersect the N-pole magnet 14a and the S-pole magnet 14b. Torque is generated on the inner rotor 16 by the intersecting magnetic fluxes and the magnetic fluxes generated by the N-pole magnet 14a and the S-pole magnet 14b. The torque rotates the shaft 12 in the direction of the arrow as shown in FIGS. 1 and 4.

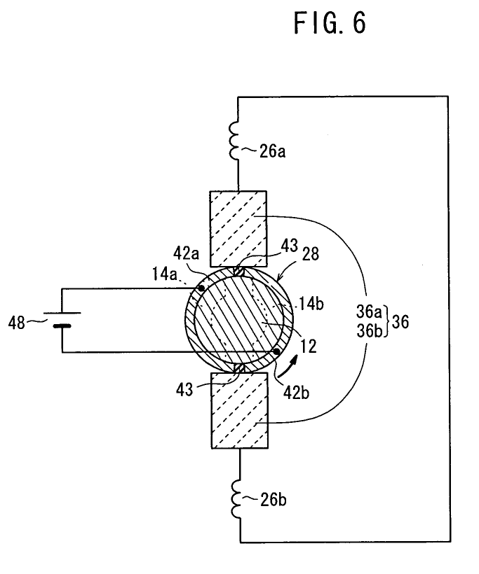

As the shaft 12 is rotated, the position of the N-pole magnet 14a is displaced to the left side of the shaft 12 shown in FIG. 6, while the position of the S-pole magnet 14b is displaced to the right side of the shaft 12. The positions of the first and second commutator pieces 42a, 42b are also displaced in response to the rotation of the shaft 12. That is, as viewed in FIG. 6, the first commutator piece 42a is displaced to the left side, and the second commutator piece 42b is displaced to the right side.

In this situation, the first and second commutator pieces 42a, 42b make conduction via the first and second coil-connecting brushes 36a, 36b. Therefore, the first and second commutator pieces 42a, 42b are electrically in a state of short circuit with respect to the DC power source 48. Accordingly, the supply of the DC current from the DC power source 48 to the first and second coils 26a, 26b is stopped.

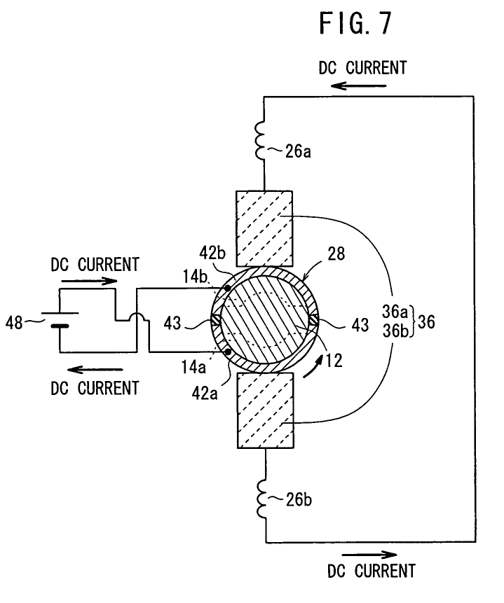

As the shaft 12 is further rotated, the position of the N-pole magnet 14a is displaced to the lower side of the shaft 12 as viewed in FIG. 7, while the position of the S-pole magnet 14b is displaced to the upper side of the shaft 12. In this situation, the position of the first commutator piece 42a is displaced to the lower side of the shaft 12, and the position of the second commutator piece 42b is displaced to the upper side of the shaft 12.

In this case, the DC current, which flows from the positive electrode of the DC power source 48 via the connector 50 (see FIG. 1), the pigtail 52, the first current-supplying brush 34a, the first current-supplying ring 45a, and the copper wire 49a (see FIG. 3) through the first commutator piece 42a, flows to the first coil-connecting brush 36a. The DC current flows from the first coil-connecting brush 36a to the second coil 26b, and the DC current further flows to the first coil 26a. The DC current, which has flown through the first coil 26a, flows from the second coil-connecting brush 36b via the copper wire 49b, the second current-supplying ring 45b, the second current-supplying brush 34b, the pigtail 52, and the connector 50 to the negative electrode of the DC power source 48.

Accordingly, the magnetic fluxes are generated from the first and second coils 26a, 26b. The magnetic fluxes extend from the first and second teeth sections 38a, 38b (see FIGS. 1 and 2) of the outer stator 20 via the air gap 18 to intersect the N-pole magnet 14a and the S-pole magnet 14b. Torque is generated on the inner rotor 16 by the action of the intersecting magnetic fluxes and the magnetic fluxes generated by the N-pole magnet 14a and the S-pole magnet 14b. The torque further rotates the shaft 12.

The foregoing explanation has been made for the case in which the DC current is allowed to flow from the DC power source 48 to the commutating section 28 in the state in which the first and second coils 26a, 26b are allowed to make contact with the first and second coil-connecting brushes 36a, 36b (see FIGS. 1, 3 to 7). However, it is a matter of course that the inner rotor 16 is rotated, for example, even when the DC current is allowed to flow through the respective commutator pieces from the DC power source 48 in a state in which a plurality of, i.e., three or more commutator pieces are arranged in place of the first and second commutator pieces 42a, 42b, and three or more coils are allowed to make contact with the respective commutator pieces.

When the positions of the N-pole magnet 14a and the S-pole magnet 14b (see FIGS. 1 and 2) are changed in accordance with the rotation of the shaft 12 when the commutating section 28a is constructed as shown in FIG. 5, then the first and second commutator pieces 42a, 42b switch the first and second current-supplying brushes 34a, 34b to make contact, corresponding to the change of the position. Accordingly, the inner rotor 16 can be rotated by allowing the DC current to flow from the DC power source 48 (see FIG. 3) to the first and second commutator pieces 42a, 42b. It is possible to suppress temporal variation or fluctuation of the torque generated on the inner rotor 16 when the inner rotor 16 makes rotational motion.

The positions of contact of the first and second coil-connecting brushes 36a, 36b with the first and second commutator pieces 42a, 42b may be moved by pressurization of an unillustrated spring, pneumatic pressure, or hydraulic pressure, or gravity of the respective brushes 36a, 36b. By doing so, it is possible to avoid a short circuit state (see FIG. 6) which occurs when the first and second commutator pieces 42a, 42b make contact with the first and second coil-connecting brushes 36a, 36b respectively. It is therefore possible to suppress temporal variation or fluctuation of the torque generated on the inner rotor 16.

Further, the DC brush motor 10 may be constructed as a motor of three or more poles by increasing the number of the coil-connecting brushes and the coils. By doing so, even when a short circuit state occurs between the two poles, the short circuit state is compensated by the DC current allowed to flow between the other two poles. Therefore, also in this case, it is possible to suppress temporal variation or fluctuation of the torque generated on the inner rotor 16.

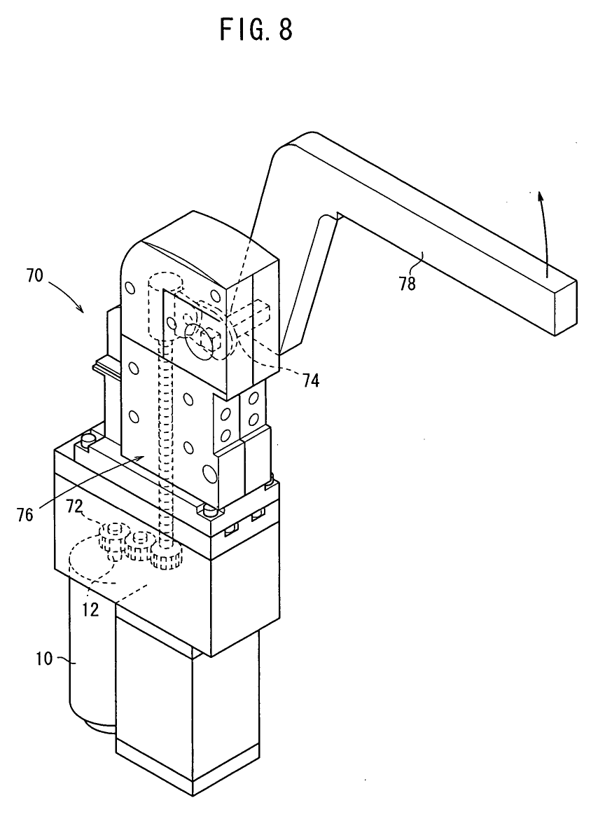

Next, an explanation will be made with reference to FIGS. 8 to 10 about exemplary applications in which the DC brush motor 10 according to the embodiment of the present invention is incorporated into an electric clamp and electric actuators.

FIG. 8 shows an example in which the DC brush motor 10 is incorporated into an electric clamp 70 (see, for example, Japanese Laid-Open Patent Publication No. 2001-310225). In this arrangement, a rotary driving mechanism 76, which is connected to the shaft 12 of the DC brush motor 10 and which is composed of a plurality of gears 72 and a toggle link mechanism 74, is provided in the electric clamp 70. A clamp arm 78 is connected to the toggle link mechanism 74. In this arrangement, the rotary driving mechanism 76 is driven in accordance with the rotation of the shaft 12, and the clamp arm 78 is rotatable in the direction of the arrow.

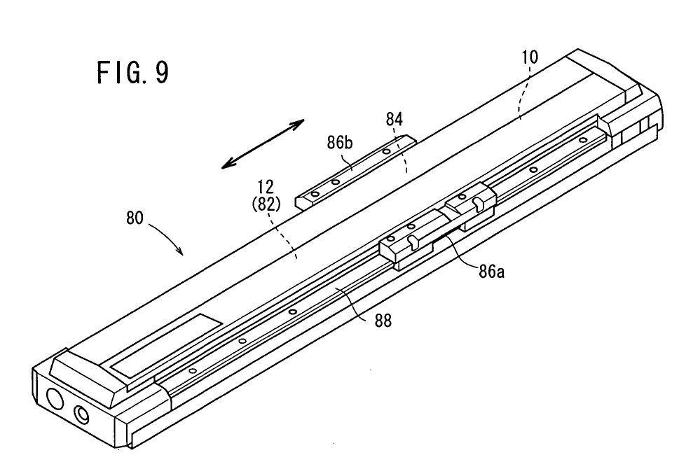

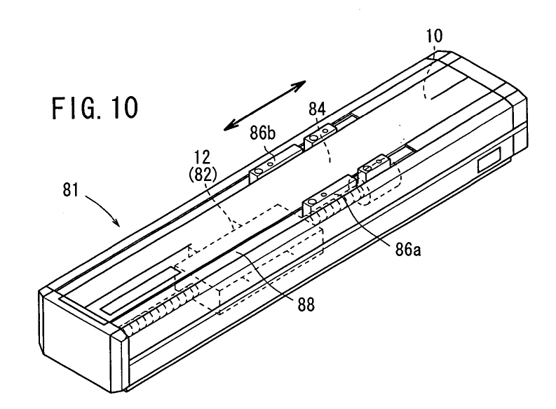

FIGS. 9 and 10 show examples in which the DC brush motor 10 is incorporated into electric actuators 80, 81 (see, for example, Japanese Laid-Open Patent Publication No. 7-284242). In this case, the DC brush motor 10 is arranged as a rotary driving source in the electric actuator 80. The shaft 12 is integrated with a ball screw 82. A ball screw bush 84, which converts the rotary motion of the shaft 12 into the rectilinear motion, is engaged with the ball screw 82. Side portions of the ball screw bush 84 are connected to table blocks 86a, 86b.

In this arrangement, when the ball screw 82 is rotated by the DC brush motor 10, then the rotary motion of the ball screw 82 is converted into the rectilinear motion by the ball screw bush 84, and the table blocks 86a, 86b make sliding movement in the direction of the arrow along a guide rail 88.

As described above, the DC brush motor 10 according to the embodiment of the present invention includes the first and second coils 26a, 26b which are arranged for the outer stator 20. Accordingly, the heat release area, which is available for the heat generated from the first and second coils 26a, 26b, can be increased as compared with the heat release area for the coil of any DC brush motor concerning the conventional technique. Therefore, when the DC current is allowed to flow from the DC power source 48 to the first and second coils 26a, 26b, the heat, which is generated from the first and second coils 26a, 26b, is transmitted to the resin 24 and the outer stator 20. Further, the heat can be efficiently released to the outside from the outer stator 20 via the motor housing 30.

In the case of the DC brush motor 10, when the heat, which is generated from the first and second coils 26a, 26b, is released to the outside, the heat can be released to the outside without passing through the air gap 18 and the permanent magnets 14a, 14b, because the heat release route does not include, for example, the air gap 18 and the permanent magnets 14a, 14b which inhibit the heat release. Therefore, the DC brush motor 10 does not include parts which inhibit heat release as compared with any DC brush motor concerning the conventional technique. It is therefore possible to efficiently release the heat in the present invention.

Further, the permanent magnets 14a, 14b are arranged in the inner rotor 16, and thus the inertial force of the inner rotor 16 is reduced. It is also easy to drive, for example, a cylinder, a clamp, and a gear by utilizing the rotary motion of the inner rotor 16. Therefore, the DC brush motor 10 can be used to quickly accelerate and/or decelerate the apparatus as described above.

When the inner rotor 16 performs the relative rotary motion with respect to the outer stator 20, the commutator pieces 42a, 42b of the commutating section 28 switch the first and second coil-connecting brushes 36a, 36b to which the DC current is allowed to flow, in response to the angle of rotation of the permanent magnets 14a, 14b. Therefore, even when the inner rotor 16 rotates, it is possible to suppress temporal variation or fluctuation of the torque generated on the inner rotor 16.

The outer stator 20 is composed of the stack of the carbon steel plates containing silicon. Therefore, the thermal conduction of the outer stator 20 is improved. The heat, which is generated from the first and second coils 26a, 26b, can be efficiently transmitted to the motor housing 30, and the heat can be released from the motor housing 30 to the outside.

The inertia of the shaft 12 is lowered by providing the permanent magnets 14a, 14b in the inner rotor 16. Accordingly, when the DC brush motor 10 is incorporated into the electric clamp 70 or the electric actuators 80, 81, the rotary driving force is transmitted to the moving element in the apparatus as described above via the shaft 12, while efficiently releasing the heat generated from the first and second coils 26a, 26b. Therefore, in the case of the DC brush motor 10 described above, the heat generation is suppressed inside. It is possible to obtain a desired thrust force in a state in which the rotation of the shaft 12 is stopped. Therefore, the thrust force can be used, for example, to rotate the clamp arm 78 shown in FIG. 8 in the direction of the arrow, and/or slide the table blocks 86a, 86b shown in FIGS. 9 and 10 in the direction of the arrow.

It is a matter of course that the DC brush motor according to the present invention is not limited to the embodiments described above, which may be embodied in other various forms without deviating from the gist or essential characteristics of the present invention.

What is claimed is:

1. A DC brush motor comprising:
an inner rotor which is provided with permanent magnets that are rotatable integrally with a rotary shaft;
an outer stator which surrounds said permanent magnets while being separated therefrom by a predetermined distance and which has a plurality of slots formed on a surface opposed to said permanent magnets;
a plurality of stator coils which are arranged in each of said slots of said outer stator;
a commutating section which is arranged coaxially with said inner rotor;
a plurality of coil-connecting brushes which make contact with one end of said commutating section and which are electrically connected to said stator coils, respectively; and
two current-supplying brushes which make contact with the other end of said commutating section and which allow a DC current to flow to said commutating section.

2. The DC brush motor according to claim 1, wherein
said commutating section includes a commutator which is electrically connected to said current-supplying brushes and which has a plurality of commutator pieces; and
said commutator pieces switch said coil-connecting brushes to which said DC current is allowed to flow, in response to an angle of rotation of said inner rotor when said inner rotor makes relative rotary motion with respect to said outer stator.

3. The DC brush motor according to claim 2, wherein said commutating section includes a plurality of slip rings which electrically connect said current-supplying brushes and said commutator pieces, respectively.

4. The DC brush motor according to claim 3, wherein said slip rings are electrically connected to said commutator pieces, respectively, via copper wires each of which has a surface coated with an insulating material.

5. The DC brush motor according to claim 3, wherein said slip rings are arranged at predetermined intervals along said rotary shaft, and said slip rings are electrically insulated from each other by insulating sections.

6. The DC brush motor according to claim 2, wherein
said commutator pieces are arranged at predetermined angular intervals on said rotary shaft;
said commutator pieces are electrically insulated from each other by insulating sections; and
said commutator is constructed by fixing said commutator pieces and said insulating sections onto said rotary shaft by using tightening rings.

7. The DC brush motor according to claim 1, wherein
said commutating section includes a commutator which is electrically connected to said coil-connecting brushes and which has a plurality of commutator pieces; and
said commutator pieces switch said current-supplying brushes to which said DC current is allowed to flow, in response to an angle of rotation of said inner rotor when said inner rotor makes relative rotary motion with respect to said outer stator.

8. The DC brush motor according to claim 7, wherein said commutating section includes a plurality of slip rings which electrically connect said commutator pieces and said coil-connecting brushes, respectively.

9. The DC brush motor according to claim 8, wherein said slip rings are electrically connected to said commutator pieces, respectively, via copper wires each of which has a surface coated with an insulating material.

10. The DC brush motor according to claim 8, wherein said slip rings are arranged at predetermined intervals along said rotary shaft, and said slip rings are electrically insulated from each other by insulating sections.

11. The DC brush motor according to claim 7, wherein
said commutator pieces are arranged at predetermined angular intervals on said rotary shaft;
said commutator pieces are electrically insulated from each other by insulating sections; and
said commutator is constructed by fixing said commutator pieces and said insulating sections onto said rotary shaft by using tightening rings.

12. The DC brush motor according to claim 1, wherein said outer stator is composed of carbon steel plates containing silicon.

13. The DC brush motor according to claim 1, wherein
a plurality of teeth sections, which are directed toward said inner rotor, are formed at predetermined angular intervals on an inner surface of said outer stator; and
said slots are formed by gaps between said teeth sections.

14. The DC brush motor according to claim 1, further comprising a motor housing which accommodates said inner rotor, said outer stator, said stator coils, and said commutating section.

15. The DC brush motor according to claim 14, further comprising a plurality of springs which have first ends connected to an inner surface of said motor housing and second ends connected to said coil-connecting brushes and said current-supplying brushes, respectively, wherein
said springs urge said coil-connecting brushes and said current-supplying brushes, respectively, to make contact with an outer surface of said commutating section.
